(19) United States
(12) Patent Application Publication
(10) Pub. No.: US 2018/0290358 A1
(43) Pub. Date: Oct. 11, 2018

(54) INDEX PLATE MOLDING DEVICE FOR MANUFACTURING INTERDENTAL CLEANERS

(71) Applicants: Rudi Locher, Kenzingen (DE); SUNSTAR SUISSE S.A., Etoy (CH)

(72) Inventors: Jürgen Butz, Schonau (DE); Rudi Locher, Kenzingen (DE)

(21) Appl. No.: 15/946,535

(22) Filed: Apr. 5, 2018

Related U.S. Application Data
(60) Provisional application No. 62/482,167, filed on Apr. 5, 2017.

(51) Int. Cl. B29C 45/16

(52) U.S. Cl. CPC B29C 45/1635; B29K 2023/12; B29C 45/1676

(57) ABSTRACT

An index plate molding device configured to produce a multi-component part including an injection mold having an injection parting surface, and an ejection mold having an ejection parting surface in selective contact with the injection parting surface to form an ejection parting line therebetween. The index plate molding device also includes an index plate movable relative to the injection mold and the ejection mold, where the index plate includes an index parting surface in selective contact with the injection parting surface to form an index parting line therebetween, and where the index plate is shaped such that the outer surface of the first component of the multi-component part is available for overmolding on both sides of the index parting line when the first component is coupled to the index plate.

### CROSS-REFERENCE TO RELATED APPLICATIONS

The present application claims priority to U.S. Patent Application No. 62/482,167, filed Apr. 5, 2017, the entire contents of which are hereby incorporated by reference.

### FIELD OF THE INVENTION

The present disclosure relates to an injection molding device and more specifically to an injection molding device having an improved index plate design and improved ejector system.

### BACKGROUND

To produce molded products there are various injection molding technologies and techniques available including, but not limited to, transfer molding, rotary table molding, core back molding, and index plate molding. Such molding techniques are well known in the oral care industry for producing toothbrushes, interdental cleaners, and the like.

In many current molding device designs (not shown), index plates may use cores or pins to provide the necessary coupling strength between the first component of the finished part and the index plate for transfer between different sets of cavities. Furthermore, it is common in the art to utilize a straight parting line between the index plate and the bottom mold.

Due to the fact that the handle part is permanently fixed to the insert plate it is normally not possible to have the second component overmolded onto both sides of the product handle (e.g., both above and below the parting line between the index plate and the upper mold). In such situations, the only way to gain access to the underside of the handle is to implement a core back solution into the index plate. Such solutions are extremely complicated and increase mold costs tremendously. Still further, once the costs are incurred, the resulting design capabilities are very restricted.

### SUMMARY

In one embodiment, the device includes an index plate molding device configured to produce a multi-component part including an injection mold having an injection parting surface, an ejection mold having an ejection parting surface in selective contact with the injection parting surface to form an ejection parting line therebetween, an index plate movable relative to the injection mold and the ejection mold, where the index plate includes an index parting surface in selective contact with the injection parting surface to form an index parting line therebetween. The index plate molding device also includes a first mold cavity at least partially defined by the index plate, where the first mold cavity is configured to produce a first component of the multi-component part, and a second mold cavity at least partially defined by the index plate, where the second mold cavity is configured to overmold a second component onto the first component of the multi-component part, and where the index plate is shaped such that the outer surface of the first component of the multi-component part is available for overmolding on both sides of the index parting line when the first component is coupled to the index plate.

In another embodiment, an index plate molding device including an injection mold having an injection parting surface, an ejection mold having an ejection parting surface in selective contact with the injection parting surface to form an ejection parting line therebetween, where the ejection mold includes an ejection-intermediate surface, and where the ejection mold is movable relative to the injection mold about an ejection axis, an index plate having an index surface in selective contact with the injection surface to form an index parting line therebetween, where the index plate includes an index-intermediate surface in selective contact with the ejection-intermediate surface to form an intermediate parting line therebetween, and where the index plate is movable relative to the injection mold about the ejection axis, and a mold cavity defined by the injection mold, the ejection mold, and the index plate, and where the intermediate parting line is non-linear as it passes through the mold cavity.

In another embodiment, the device provides an index plate molding device including, an injection mold having an injection parting surface, an index plate having an index parting surface in selective contact with the injection parting surface to form an index parting line therebetween, where the index plate defines a channel, an ejection mold having an ejection parting surface in selective contact with the injection parting surface to form an ejection parting line therebetween, where at least a portion of the second mold portion is positioned within the channel of the index plate, and a mold cavity defined by the first mold portion, the second mold portion, and the index plate.

In another embodiment, an index plate molding device including, an injection mold having an injection parting surface, an ejection mold having an ejection parting surface in selective contact with the injection parting surface to form an ejection parting line therebetween, an index plate having an index parting surface in selective contact with the injection parting surface to form an index parting line therebetween, where the index plate includes a first locking surface and a second locking surface, and where the first locking surface is substantially parallel to and facing opposite to the second locking surface, and a mold cavity defined by the injection mold, the ejection mold, and the index plate.

In another embodiment, the device provides a method of forming a multi-component part using an index plate molding device having an injection mold with an injection parting surface, an ejection mold with an ejection parting surface in selective contact with the injection parting surface to form an ejection parting line therebetween, and an index plate having an index parting surface in selective contact with the injection parting surface to form an index parting line therebetween. The method including positioning the injection mold, the ejection mold, and the index mold to form a first mold cavity defined therebetween, injecting a first material into the first mold cavity to form a first component of the multi-component part, allowing the first material to cool such that the first component is frictionally coupled to the index plate so that the first component is available for overmolding on both sides of the second parting line, re-positioning the index plate, the injection mold, and the ejection mold to form a second mold cavity having a second shape than the first mold cavity and position at least a portion of the first component therein, and overmolding a second material onto the first component.

Other aspects of the disclosure will become apparent by consideration of the detailed description and accompanying drawings.

### BRIEF DESCRIPTION OF THE DRAWINGS

FIG. 1 is a top view of an index plate molding device.

FIG. 2 is a detailed view of the interaction between an index plate and a bottom mold from the index plate molding device of FIG. 2.

FIG. 3 is a detailed view of the interaction between the index plate and the bottom mold of FIG. 2.

FIG. 4 is a top view of an index plate of FIG. 1.

FIG. 5 is a detailed perspective view of the index plate of FIG. 4.

FIG. 6 is a perspective view of the index plate molding device of FIG. 1 with the index plate in the deployed position.

FIG. 7 is a section view taken along line 7-7 of FIG. 3 with the mold in a closed configuration before a first injection process.

FIG. 8 is the section view of FIG. 7 with the mold in an open configuration and the index plate in the deployed position.

FIG. 9 is the section view of FIG. 7 with the mold in a closed configuration after the second injection process.

FIG. 10 is a top view of an interdental cleaner.

FIG. 11 is a section view taken along line 11-11 of FIG. 10.

FIG. 12 is a section view taken along line 12-12 of FIG. 10.

FIG. 13 is a section view taken along line 13-13 of FIG. 1 with the mold in a closed configuration.

### DETAILED DESCRIPTION

Before any embodiments of the test tube holder are explained in detail, it is to be understood that the injection molding device is not limited to the details set forth in the following description or illustrated in the accompanying drawings. The injection molding device is capable of supporting other implementations and of being practiced or of being carried out in various ways.

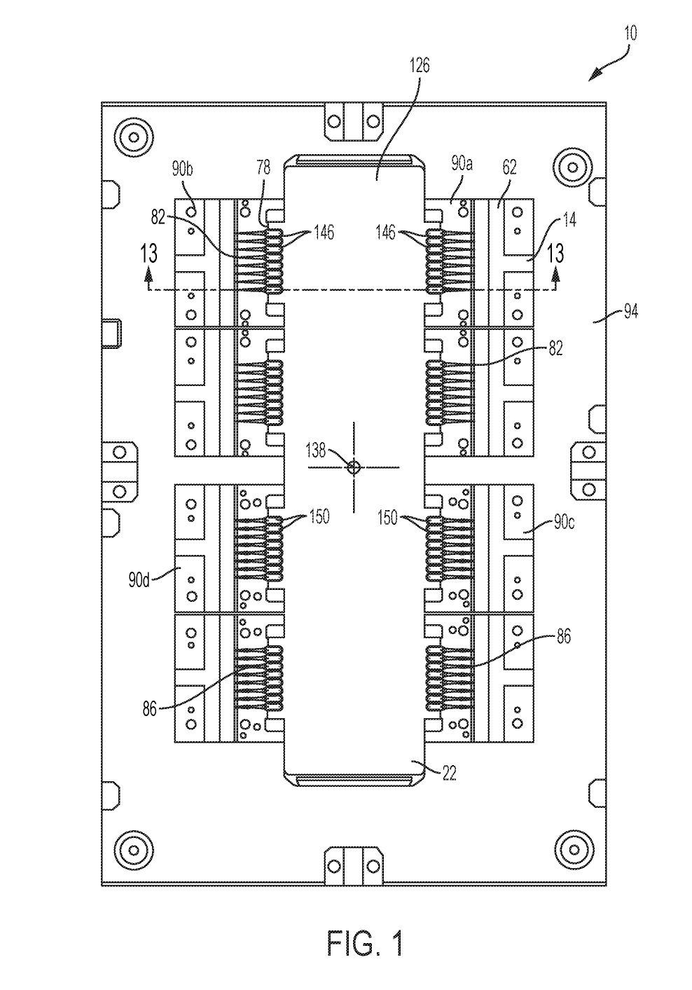

FIGS. 1-9 illustrate an injection molding device configured to produce a multi-component part using an index plate molding process. More specifically, the present device produces wireless interdental cleaners or part thereof via a two-component injection-molding process. The molding device includes an improved index plate design that allows a greater percentage of the outer surface of the first or core component of the part to be available for overmolding by a second component than is available using current index plate designs. In particular, the index plate allows overmolding onto the first component's outer surfaces positioned both above and below the parting plane formed between the upper mold and the index plate. In addition to increasing the amount of surface area available for overmolding, the improved index plate design also maintains sufficient holding strength between the index plate and the first component to allow the first component to be moved between different mold cavities during the molding process. The injection molding device also includes a secondary ejection device having one or more ejection rods that move at approximately the same speed as the index plate to minimize bending and deformation of the first component when the first component is being removed from the ejection side mold.

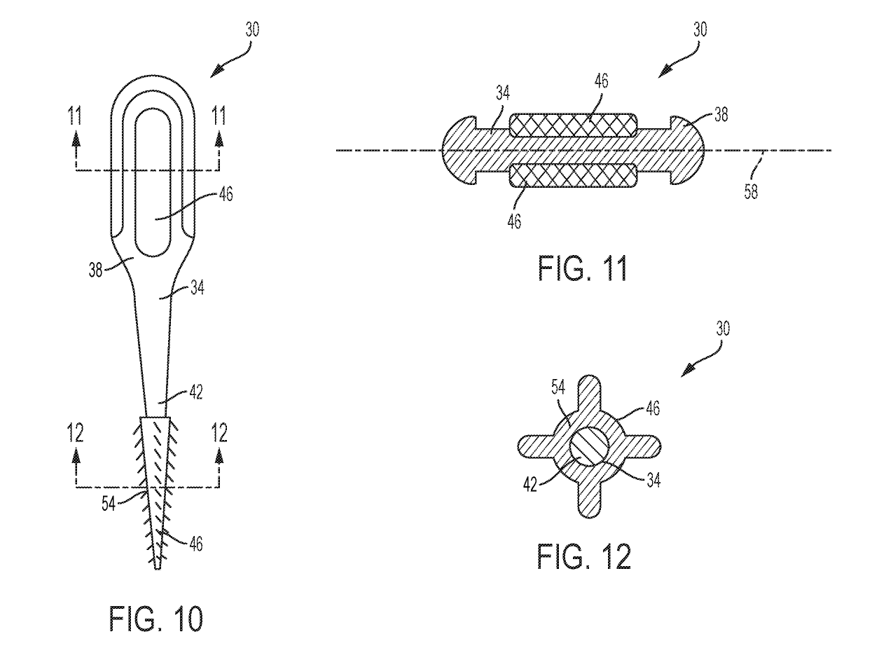

For the purposes of this application, the multi-component interdental cleaner 30 includes a first component 34 having a handle portion 38, and a tip portion 42 extending from the handle portion 38 (see FIG. 10). In the illustrated embodiment, the first component 34 is generally formed from a stiffer and more durable material such as polypropylene (PP) and the like.

The interdental cleaner 30 also includes a second component 46 overmolded onto the outer surface 50 of the first component 34 in one or more locations. In the illustrated embodiment, the second component 46 completely encompasses the tip portion 42 of the first component 34 to form a cleaning part 54 (see FIG. 12). Furthermore, the second component 46 is applied to the handle portion 38 of the first component 34 both above and below a mid-plane 58 formed by the handle portion 38 (see FIG. 11). In the illustrated embodiment, the second component 46 is generally formed from a softer material such as thermoplastic elastomer (TPE).

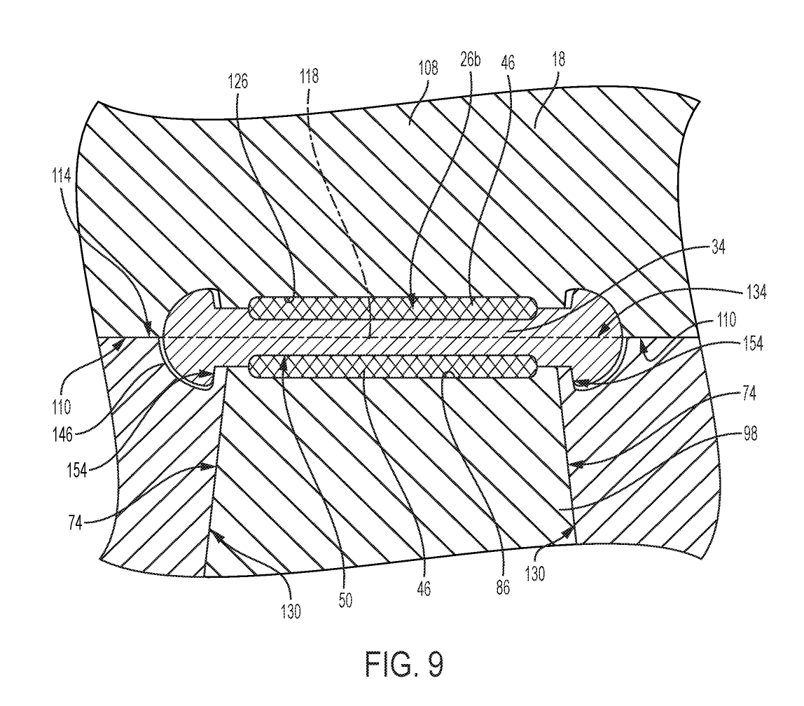

Illustrated in FIGS. 1-9, the molding device 10 of the present invention includes a bottom or ejection mold 14, a top or injection mold 18, and an index plate 22 movable with respect to both the ejection mold 14 and the injection mold 18. Together, the injection mold 18, the ejection mold 14, and the index plate 22 form a plurality of mold cavities 26a, b sized and shaped to create a multi-component part such as an interdental cleaner 30 (see FIGS. 7 and 9). In the illustrated embodiment, the first set of mold cavities 26a are sized and shaped to form the first component or core 34 of the interdental cleaner 30 therein while the second set of mold cavities 26b are sized and shaped to at least partially define the size, shape, and location where the second component 46 will be overmolded onto the outer surfaces 50 of the first component 34.

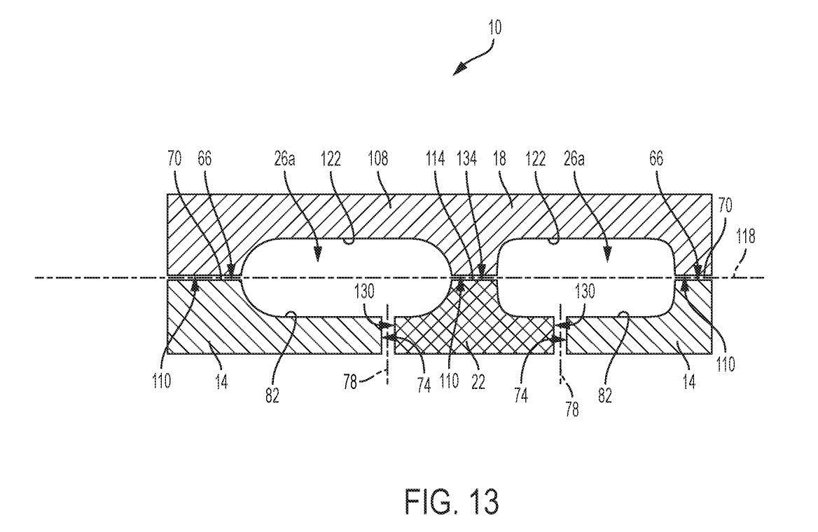

Illustrated in FIGS. 1-3 and 6-9, the ejection mold 14 of the molding device 10 includes a body 62 having an ejection parting surface 66 configured to engage and form an ejection parting line 70 with the injection mold 18 (see FIG. 13), and an ejection-intermediate surface 74 configured to engage and form an intermediate parting line 78 with the index plate 22 of the molding device 10. The ejection mold 14 also defines a first and second set of depressions 82, 86 both formed into the ejection parting surface 66 of the body 62 and configured to at least partially define the first set of mold cavities 26a and the second set of mold cavities 26b, respectively. In the illustrated embodiment, the first set of depressions 82 is shaped differently than the second set of depressions 86.

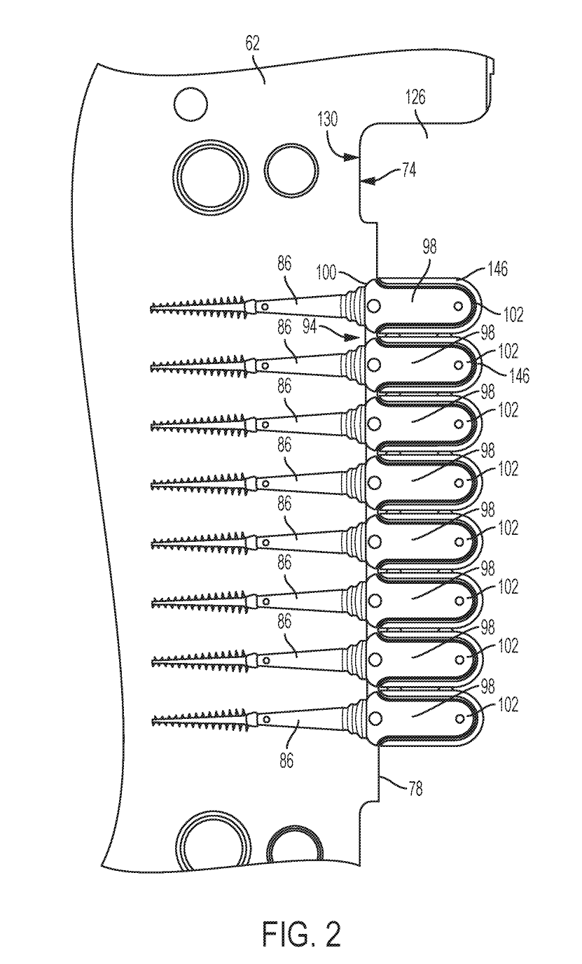

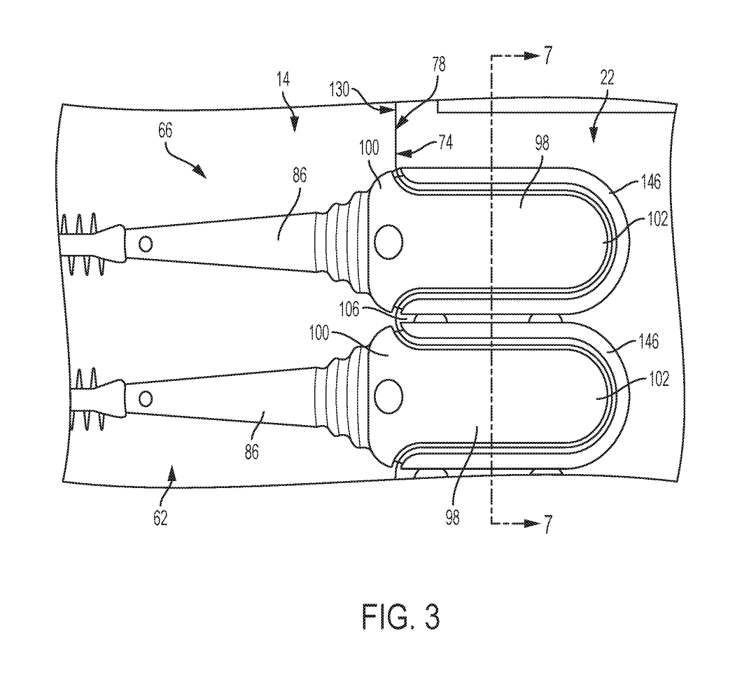

Best illustrated in FIGS. 2 and 3, the body 62 of the ejection mold 14 includes a plurality of protrusions 98, each extending outwardly from a base 100 to produce a distal end 102. In the illustrated embodiment, each protrusion 102 generally corresponds to and at least partially defines one of a first depression 82 or a second depression 86. During use, the protrusions 98 of the body 62 are sized and shaped to intermesh with corresponding channels 112 of the index plate 22 (described below) forming a non-linear intermediate parting line 78 therebetween. In the illustrated embodiment, the protrusions 102 of the bottom mold 14 at least partially define the ejection-intermediate surface 74.

In the illustrated embodiment, the body 62 of the ejection mold 14 is formed from a plurality of plates 90a-d, each coupled to a common base 94. However, in alternative embodiments, the ejection mold 14 may be formed from a single piece of material (not shown).

Illustrated in FIGS. 7, 9, and 13, the injection mold 18 of the molding device 10 includes a body 108 having an injection parting surface 110. The injection parting surface 110 is configured to engage and form the ejection parting line 70 with the ejection mold 14 and engage and form an index parting line 114 with the index plate 22 (see FIG. 13). Together, the ejection parting line 70 and the index parting line 114 formed by the injection parting surface 110 of the injection mold 18 defines a parting plane 118 generally separating the upper mold 18 from the bottom mold 14 and the index plate 22 (see FIGS. 7, 8, and 13).

The injection mold 18 defines a first set of depressions 122 and a second set of depressions 128, each formed into the injection parting surface 110 of the body 108 and configured to at least partially define the first set of cavities 26a and the second set of cavities 26b, respectively. In the illustrated embodiment, the first set of depressions 122 are shaped differently than the second set of depressions 122.

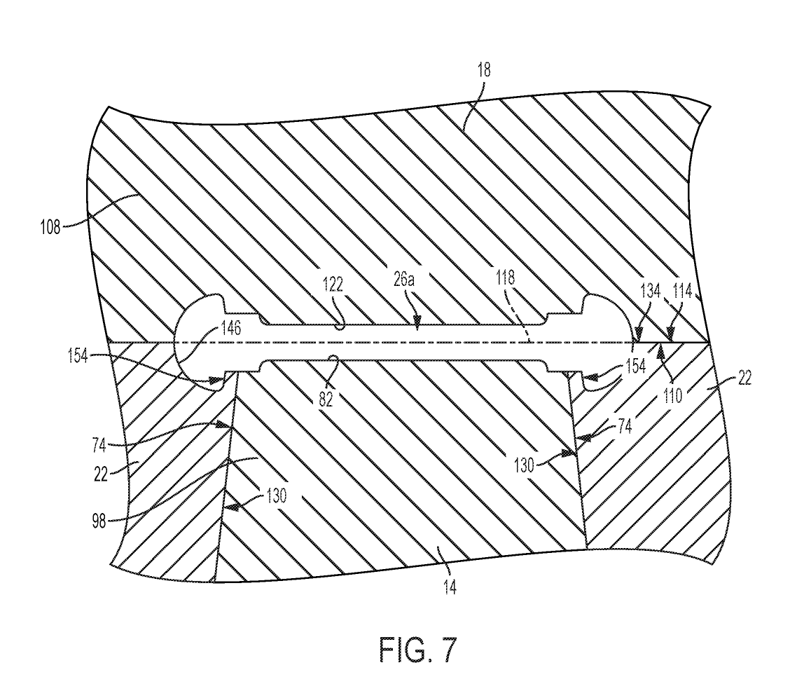

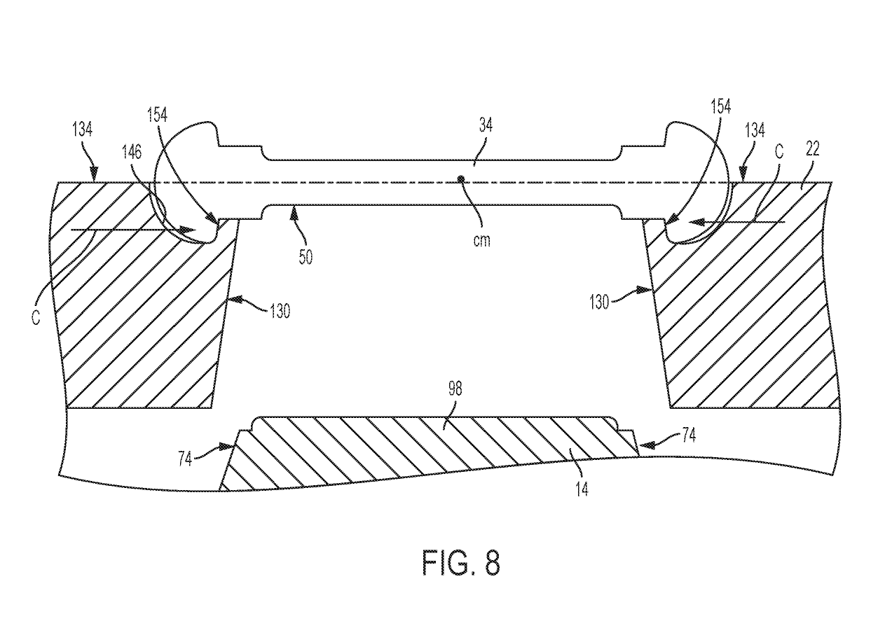

During operation, the injection mold 18 of the molding device 10 is movable with respect to the ejection mold 14 between a closed position (see FIGS. 7 and 9) and an open position (see FIG. 8). In the closed position, the injection parting surface 110 of the injection mold 18 is in contact with and engages the ejection parting surface 66 of the ejection mold 14 enclosing the first and second sets of cavities 26a, b therebetween. In the open position, the injection parting surface 110 of the injection mold 18 is not in contact with the ejection parting surface 66 of the ejection mold 14 such that the interior of the first and second sets of cavities 26a,b are accessible from the outside. In the illustrated embodiment, the injection mold 18 is movable with respect to the ejection mold 14 about an ejection axis 138 that is substantially normal to at least one of the parting plane 118, the ejection parting line 70, and the index parting line 114.

Illustrated in FIGS. 1-9 and 13, the index plate 22 of the molding device 10 includes a body 126 having an index-intermediate parting surface 130 configured to engage and form the intermediate parting line 78 with the ejection mold 14 (see FIG. 3), and an index parting surface 134 configured to engage and form the index parting line 114 with the injection mold 18 (see FIG. 13). The index plate 22 also defines the ejection axis 138 positioned proximate the center of the body 126 and extending therethrough (see FIG. 1). During use, the index plate 22 is movable relative to the ejection mold 14 and the injection mold 18 both axially along and rotationally about the ejection axis 138.

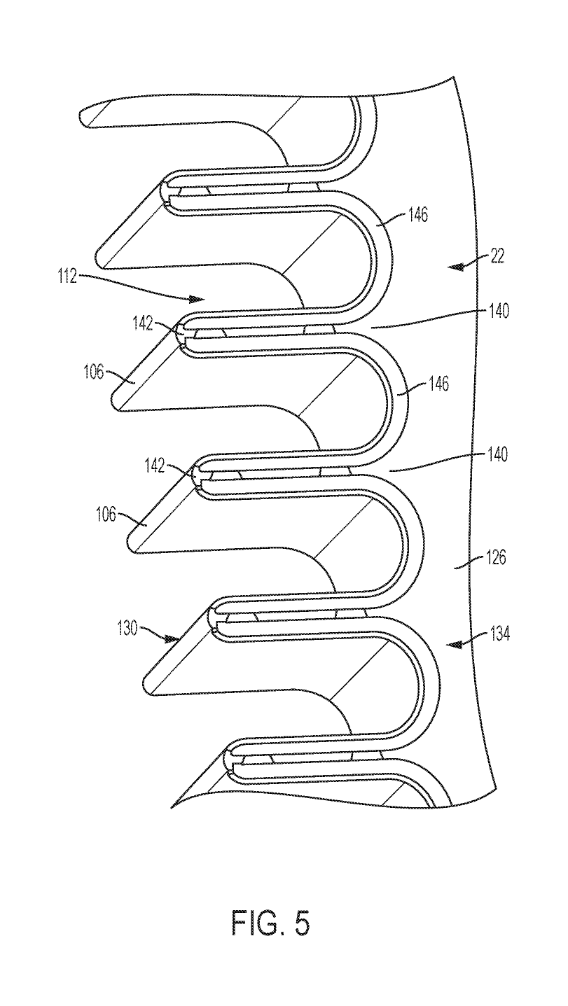

Best illustrated in FIG. 5, the body 126 of the index plate 22 includes a plurality of protrusions 106 each extending outwardly from a base 140 to produce a distal end 142. In the illustrated embodiment, each mold cavity 26a, 26b includes a pair of protrusions 106 defining a channel 112 therebetween. Furthermore, the protrusions 106 and corresponding channels 112 at least partially form the index-intermediate surface 130 and therefore are at least partially defined by the intermediate parting line 78. During use, at least a portion of the ejection mold 14 is positioned within the channel 112. More specifically, the protrusions 106 and channels 112 of the body 126 are sized and shaped to intermesh with corresponding protrusions 98 of the ejection mold 14 to form a non-linear intermediate parting line 78 therebetween (see FIG. 3). More specifically, the intermediate parting line 78 is non-linear as it passes through at least one of the cavities 26a, 26b. In still other embodiments, the intermediate parting line 78 may be curvlinear.

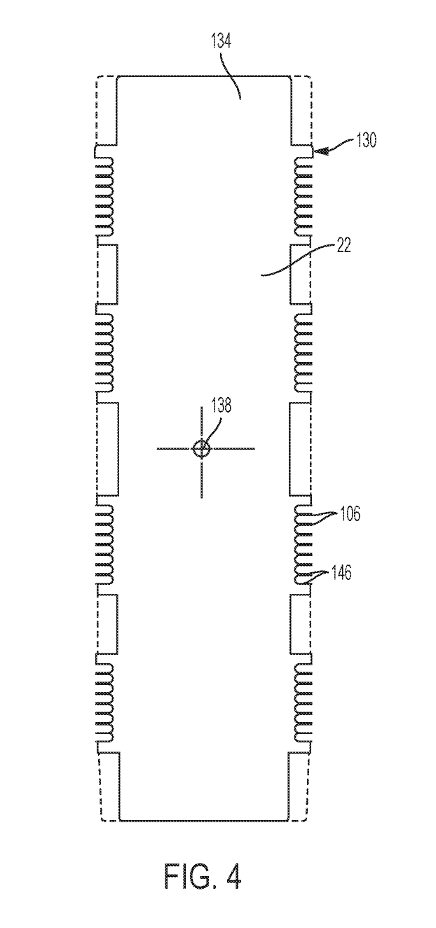

In the illustrated embodiment, the intermediate parting line 78 substantially corresponds with the outer contour of the handle portion 38 of the first component 34 being slightly offset inwardly therefrom. More specifically, the intermediate parting line 78 is substantially an equal distance from the periphery of the handle portion 38 of the first component 34 for a majority of its path through the first component 34. Furthermore, the protrusions 106 and channels 112 of the index plate 22 extend substantially perpendicular to the ejection axis 138. As shown in FIG. 4, the body 126 of the index plate 22 also defines a footprint 127, where the footprint 127 includes a rectangle with the body 126 inscribed therein.

The index plate 22 also defines first and second sets of depressions 146, 150, each at least partially defining either the first set of cavities 26a or the second set of cavities 26b depending upon the orientation of the index plate 22 with respect to the upper and bottom molds 14, 18 (described below). In the illustrated embodiment, the first and second sets of depressions 146, 150 are substantially similar in size and shape and configured to support the first component 34 of the multi-component part such that the first component 34 is available for overmolding on both sides of the index parting line 78 when the first component 34 is coupled to the index plate 22.

As shown in FIGS. 3 and 5, each depression 146, 150 of the index plate 22 extends between two adjacent protrusions 106 forming an elongated groove having a substantially “U” shape. More specifically, each depression 146, 150 of the index plate 22 generally originates proximate the distal end 142 of a first protrusion 106, extends along and between the first protrusion and a second protrusion, then terminates proximate the distal end 142 of the second protrusion 106.

The size and shape of the first and second sets of depressions 146, 150 at least partially determine the areas of the outer surface 50 of the first component 34 placed in direct contact with the index plate 22 after the first component 34 is formed. Since the areas of the first component 34 in direct contact with the index plate 22 remain coupled to the index plate 22 throughout the duration of the molding process, those areas cannot be overmolded by the second component 46. As such, the size and shape of the depressions 146, 150 at least partially determine the areas of the first component 34 that are available for overmolding (e.g., areas that are not in direct contact with the index plate 22). In the illustrated embodiment, the substantially “U” shaped contour of the depressions 146, 150 places only the periphery of the handle portion 38 in direct contact with the index plate 22. As such, the interior areas on both sides of the handle portion 38 (e.g., above and below the index parting line 78) are available for overmolding by the second component 46. Stated differently, the first component 34 is coupled to the index plate 22 such that the outer surface 50 of the first component 34 is available or overmolding both above and below the index parting line 78.

Best illustrated in FIG. 8, each depression 146, 150 of the index plate 22 forms a cross-sectional shape that includes a first and a second locking surfaces 154. Together, the locking surfaces 154 are configured to frictionally engage corresponding surfaces of the first component 34. More specifically, the locking surfaces 154 are positioned and oriented such that, as the first component 34 cools within the cavity 26a after the first injection process, the thermal contraction of the component 34 applies a compressive force C against the locking surface 154 causing frictional engagement therebetween (see FIG. 8). The resulting frictional engagement creates a holding force that helps secure the first component 34 to the locking surfaces 154 and, correspondingly, the first component 34 to the index plate 22. The locking surfaces 154 allow the index plate 22 to produce sufficient holding strength between the index plate 22 and the first component 34 while minimizing the amount of surface area in direct contact between the two elements (e.g., unable to be overmolded with the second component 46). Stated differently, the index plate 22 is configured such that at least a portion of the holding strength between the index plate 22 and the first component 34 is produced by the compressive force produced by the thermal contraction of the first component 34.

In the illustrated embodiment, the first and second locking surfaces 154 of the index plate 22 include two surfaces oriented substantially parallel to and facing opposite one another. Each locking surface 154 is also substantially parallel to the ejection axis 138 (see FIG. 5). When the first component 34 shrinks in volume as it cools (e.g., generally toward the center of mass CM, see FIG. 8), the surfaces of the first component 34 immediately opposite the locking surface 154 will shrink inwardly, thereby applying a compressive clamping force C against the two opposing locking surfaces 154 (see FIG. 8). In the illustrated embodiment, the locking surfaces 154 are between approximately 0.1 mm and approximately 2 mm in height. In other embodiments, the locking surfaces 154 are approximately 0.2 mm to approximately 0.8 mm in height.

While the illustrated embodiment illustrates the first and second locking surfaces 154 being formed as a single “U” shaped surface 154, it is to be understood that more or different shaped locking surfaces may be used so long as thermal shrinkage of the corresponding component causes a compressive force to be applied thereto. For example, two or more opposing surfaces or pegs positioned on either side of the part's center of mass CM may be used (not shown). In still another example, a circular surface centered about the center of mass CM may be used.

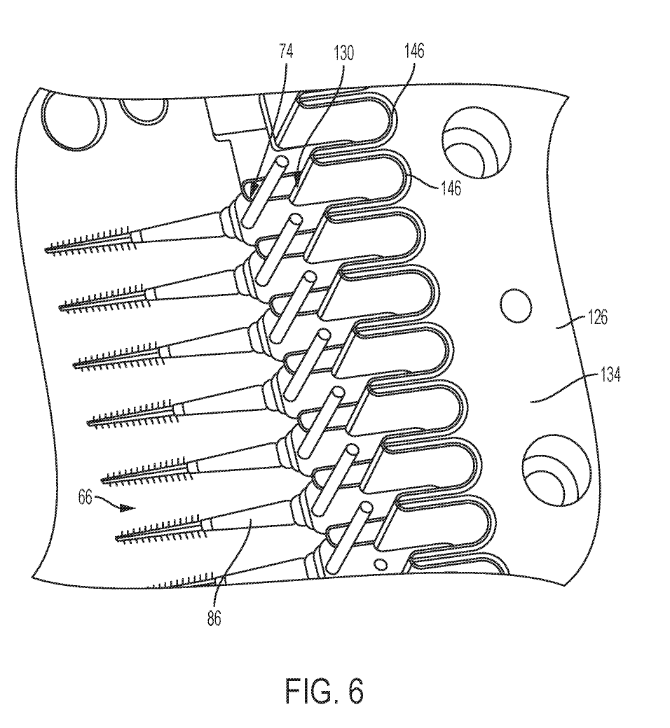

During use, the index plate 22 is movable with respect to the ejection mold 14 and the injection mold 18, both translationally and rotationally. More specifically, the index plate 22 is movable axially along the ejection axis 138 between a set position (see FIGS. 7 and 9), where the index plate 22 is substantially aligned with the ejection mold 14, and a deployed position (see FIGS. 6 and 8), where the index plate 22 is not aligned with the ejection mold 14. Furthermore, the index plate 22 is movable rotationally about axis 138 between a first orientation (see FIG. 1), and a second orientation (not shown). In the first orientation, the first depressions 146 of the index plate 22 are substantially aligned with the first depressions 82 of the ejection mold 14 to at least partially define the first set of cavities 26a while the second set of depressions 150 of the index plate 22 are substantially aligned with the second set of depressions 86 of the ejection mold 14 to at least partially define the second set of cavities 26b. In the second orientation, the index plate 22 is rotated approximately 180 degrees from the first orientation, such that the first depressions 146 of the index plate 22 are substantially aligned with the second depressions 86 of the ejection mold 14 to at least partially define the second set of cavities 26b while the second set of depressions 150 of the index plate 22 are substantially aligned with the first set of depressions 82 of the ejection mold 14 to at least partially define the first set of cavities 26a.

The molding device 10 also includes a first ejection system (not shown) coupled to the bottom mold 14 and in operable communication with the second set of cavities 26b. The first ejection system is configured to eject the finished set of interdental cleaners 30 from the second set of cavities 26b after the molding process is complete. The first ejection system may be driven by compressed air, a spring, an actuator, and the like.

The molding device 10 also includes a second ejection system (not shown) coupled to the upper mold 18 and in operable communication with second set of cavities 26b. The second ejection system is configured to press against the finished interdental cleaners 30 as the mold opens to assure the interdental cleaner 30 does not stick the injection mold 18. The second ejection system may be driven by compressed air, a spring, an actuator, or the like.

The molding device 10 also includes a third ejection system 158 coupled to the ejection mold 14 and in operable communication with the first set of cavities 26a (see FIG. 6). The third ejection system 158 is configured to eject the finished first component 34 from its respective first cavity 26a as the index plate 22 moves from the set position (FIG. 7) toward the actuated position (FIG. 6). The third ejection system 158 includes a plurality of ejection rods 162, each having distal ends 166 configured to engage the first component 34 and bias it away from the bottom mold 14 in an even manner to minimize any damage or deformation to the part. In the illustrated construction, ejection rods 162 are generally positioned along the length of the first component 34 including near the tip portion 42. During operation, the distal ends 166 of the third ejection system 158 are configured to move in a synchronized manner with respect the index plate 22 such that the distal ends 166 remain in a fixed position with respect to the plate 22 during the ejection process. In some embodiments, the ejection rods 162 may include a follow rod (not shown) in contact with the underside of the index plate 22 to at least partially control the movement of the ejection rod 162.

During the molding process, the molding device 10 begins with the index plate 22 in the set position translationally and the first orientation rotationally. As such, the index plate 22 is substantially aligned with the ejection mold 14 and rotationally oriented so that the first depressions 146 of the index plate 22 are aligned with the first depressions 82 of the bottom mold 14. Likewise, the second depressions 150 of the index plate 22 are aligned with the second depressions 86 of the ejection mold 14. The molding device 10 also begins with the injection mold 18 in the closed position (see FIGS. 9 and 7). As such, the injection parting surface 110 of the injection mold 18 is in contact with the ejection parting surface 66 of the ejection mold 14 and the index parting surface 134 of the index plate 22, substantially enclosing the first and second sets of cavities 26a, b therebetween.

With the molding device 10 initialized, the molding process begins with a first injection step. During the first injection step, the molding device 10 injects a pre-metered amount of molding material (e.g., PP) into each of the first cavities 26a via an injection point (not shown). As the molding material enters each cavity 26a, the material fills the volume forming the first component 34 therein. The first component 34 then begins to cool and solidify, causing the first component 34 to thermally contract in size and apply compressive forces C against the locking surfaces 154 of the index plate 22 (see FIG. 7, described above). Furthermore, the area of the outer surface 50 of the first component 34 adjacent the first depression 146 of the index plate 22 comes in direct contact with the index plate 22 becoming coupled thereto.

Once the first component 34 of the interdental cleaner 30 has sufficiently cooled, the injection mold 18 moves to the open position along the ejection axis 138 (described above). With the mold open, the index plate 22 moves axially away from the set position and toward the actuated position along the ejection axis 138 (see FIG. 8). Simultaneously, the distal ends 166 of the third ejection system 158 move together with the index plate 22 helping to eject the first component 34 from the first depression 82 of the ejection mold 14 (see FIG. 6).

As the index plate 22 moves from the set position toward the actuated position, the first component 34 remains coupled to the index plate 22 through a combination of the holding force provided by the area of the first component 34 in direct contact with the index plate 22 and the compressive force exerted against the locking surfaces 154. As such, the index plate 22 and the first component 34 move together as a unit.

After the index plate 22 enters the actuated position, the index plate 22 rotates about the ejection axis 138 from the first position and toward the second position. By doing so, the index plate 22 carries the first components 34 out of alignment with their corresponding first cavities 26a and into alignment with a corresponding one of the second set of cavities 26b. Simultaneously, the empty second set of depressions 150 from a previously completed cycle moves into alignment with the first set of cavities 26a.

With the index plate 22 in the second position, the index plate 22 returns to the set position (e.g., axially along the ejection axis 138) thereby placing the index plate 22 back into alignment with the ejection mold 14. The injection mold 18 then returns to the closed position (e.g., axially along the ejection axis 138) thereby enclosing each of the first components 34 within a corresponding one of the second set of cavities 26b (see FIG. 9).

With the first components 34 positioned within the second set of mold cavities 26b, the molding device 10 then undergoes the second injection step. During the second injection step, the molding device 10 injects a pre-metered amount of a second molding material (e.g., TPE) into each of the second cavities 26b. As the molding material enters each cavity 26b, the material fills the void formed between the first component 34 and the cavity 26b, allowing the second component 46 to be overmolded onto the outer surface 50 of the first component 34. In particular, the second component 46 may be overmolded onto any area of the outer surface 50 of the first component 34 not in direct contact with the index plate 22, including both sides of the handle 38 (e.g., on both sides of the index parting line 78). In some embodiments, the second injection material is overmolded onto the injection site of the first component 34 (e.g., the position on the first component 34 that corresponds with the location where the first material entered the first set of mold cavities 26a) to cover the injection site of the first component 34 such that it is not visible in the final product.

Once the finished part has sufficiently cooled, the injection mold 18 moves into the open position and the finished part 30 is ejected from the cavity 26b for subsequent collection. The molding device 10 is then ready to reset to the initial start position and begin the cycle anew.

1. An index plate molding device configured to produce a multi-component part comprising:
an injection mold having an injection parting surface;
an ejection mold having an ejection parting surface in selective contact with the injection parting surface to form an ejection parting line therebetween;
an index plate movable relative to the injection mold and the ejection mold, wherein the index plate includes an index parting surface in selective contact with the injection parting surface to form an index parting line therebetween;
a first mold cavity at least partially defined by the index plate, wherein the first mold cavity is configured to produce a first component of the multi-component part; and
a second mold cavity at least partially defined by the index plate, wherein the second mold cavity is configured to overmold a second component onto the first component of the multi-component part, and
wherein the index plate is shaped such that the outer surface of the first component of the multi-component part is available for overmolding on both sides of the index parting line when the first component is coupled to the index plate.

2. The index plate molding device of claim 1, wherein the ejection mold is movable relative to the injection mold about an ejection axis, and wherein the index plate is movable relative to the injection mold about the ejection axis, and wherein the ejection parting line and the index parting line are generally normal to the ejection axis.

3. The index plate molding device of claim 1, wherein the first mold cavity and the second mold cavity are defined by the injection mold, the ejection mold, and the index plate.

4. The index plate molding device of claim 1, wherein the index plate includes a first protrusion having a first distal end and a second protrusion having a second distal end, and wherein the index plate also defines a channel between the first protrusion and the second protrusion.

5. The index plate molding device of claim 4, wherein at least a portion of the ejection mold is positioned within the channel of the index plate.

6. The index plate molding device of claim 1, wherein the index plate includes a first locking surface and a second locking surface, and wherein the first locking surface is substantially parallel to and facing opposite the first locking surface.

7. The index plate molding device of claim 6, wherein the first locking surface and the second locking surface are continuous.

8. The index plate molding device of claim 6, wherein the index plate is movable relative to the injection mold about an ejection axis, and wherein the first locking surface and the second locking surface are substantially parallel to the ejection axis.

9. The index plate molding device of claim 1, wherein the first component of the multi-component part clamps onto the index plate upon cooling.

10. An index plate molding device comprising:
an injection mold having an injection parting surface;
an ejection mold having an ejection parting surface in selective contact with the injection parting surface to form an ejection parting line therebetween, wherein the ejection mold includes an ejection-intermediate surface, and wherein the ejection mold is movable relative to the injection mold about an ejection axis;
an index plate having an index surface in selective contact with the injection surface to form an index parting line therebetween, wherein the index plate includes an index-intermediate surface in selective contact with the ejection-intermediate surface to form an intermediate parting line therebetween, and wherein the index plate is movable relative to the injection mold about the ejection axis; and
a mold cavity defined by the injection mold, the ejection mold, and the index plate, and wherein the intermediate parting line is non-linear as it passes through the mold cavity.

11. The index plate molding device of claim 10, wherein the index parting line is generally normal to the ejection axis.

12. The index plate molding device of claim 10, wherein the index plate defines a channel extending substantially perpendicular to the ejection axis, and wherein at least a portion of the ejection mold is positioned within the channel.

13. The index plate molding device of claim 10, wherein a cross-section taken parallel to the ejection axis and passing through the index parting line but not through the ejection parting line passes through the injection mold on one side of the index parting line, and both the index plate and the ejection mold on the other side of the index parting line.

14. An index plate molding device comprising:
an injection mold having an injection parting surface;
an index plate having an index parting surface in selective contact with the injection parting surface to form an index parting line therebetween, wherein the index plate defines a channel;
an ejection mold having an ejection parting surface in selective contact with the injection parting surface to form an ejection parting line therebetween, wherein at least a portion of the second mold portion is positioned within the channel of the index plate; and
a mold cavity defined by the first mold portion, the second mold portion, and the index plate.

15. The index plate molding device of claim 14, wherein the portion of the ejection mold positioned within the channel of the index plate at least partially defines the mold cavity.

16. The index plate molding device of claim 14, wherein the index plate includes an index-intermediate surface, and wherein the ejection mold includes an ejection-intermediate surface in selective contact with the index-intermediate surface to form an intermediate parting line therebetween.

17. The index plate molding device of claim 16, wherein the channel is at least partially defined by the intermediate parting line.

18. The index plate molding device of claim 14, wherein the ejection mold is movable relative to the injection mold about an ejection axis, and wherein the channel extends substantially perpendicular to the ejection axis.

19. An index plate molding device comprising:
an injection mold having an injection parting surface;
an ejection mold having an ejection parting surface in selective contact with the injection parting surface to form an ejection parting line therebetween;
an index plate having an index parting surface in selective contact with the injection parting surface to form an index parting line therebetween, wherein the index plate includes a first locking surface and a second locking surface, and wherein the first locking surface is substantially parallel to and facing opposite to the second locking surface; and
a mold cavity defined by the injection mold, the ejection mold, and the index plate.

20. The index plate molding device of claim 19, wherein the ejection mold is movable relative to the injection mold via an ejection axis, and wherein the first locking surface and the second locking surface are substantially parallel to the ejection axis.

21. The index plate molding device of claim 19, wherein the index plate is shaped such that the thermal contraction of a part within the mold cavity causes the part to frictionally engage the first locking surface and the second locking surface.

22. A method of forming a multi-component part using an index plate molding device having an injection mold with an injection parting surface, an ejection mold with an ejection parting surface in selective contact with the injection parting surface to form an ejection parting line therebetween, and an index plate having an index parting surface in selective contact with the injection parting surface to form an index parting line therebetween, the method comprising:
positioning the injection mold, the ejection mold, and the index mold to form a first mold cavity defined therebetween;
injecting a first material into the first mold cavity to form a first component of the multi-component part;
allowing the first material to cool such that the first component is frictionally coupled to the index plate so that the first component is available for overmolding on both sides of the second parting line;
re-positioning the index plate, the injection mold, and the ejection mold to form a second mold cavity having a second shape than the first mold cavity and position at least a portion of the first component therein;
overmolding a second material onto the first component.
